(19) United States
(12) Patent Application Publication
(10) Pub. No.: US 2013/0132609 A1
(43) Pub. Date: May 23, 2013

(54) METHOD FOR IDENTIFYING DEVICES COMBINED IN COMMUNICATION NETWORK

(71) Applicant: SIEMENS AKTIENGESELLSCHAFT, Munich (DE)

(72) Inventor: André MEIER, Risch (CH)

(73) Assignee: SIEMENS AKTIENGESELLSCHAFT, Munich (DE)

(21) Appl. No.: 13/684,361

(22) Filed: Nov. 23, 2012

(30) Foreign Application Priority Data
Nov. 23, 2011 (EP) 11190245.8

(51) Int. Cl. H04L 29/12

(52) U.S. Cl. CPC H04L 61/2007
USPC 709/245

(57) ABSTRACT

A higher-level device identifies devices in a communication network; each device assigned a unique address in a predefined address space. The higher-level device subdivides the address space into request regions, each including a variable, automatically determined number of addresses, and sends an identification request to all the addresses in a request region. Devices receiving the identification request return an identification code. The higher-level device collects the identification codes received and compares the number of identification codes received with a predefined threshold value. If the number of identification codes received is below the threshold value, the method is continued with a new request region bordering the request region. If the number of identification codes received is above the threshold value, the method is continued with a reduced request region which is a subset of the request region, wherein the reduced request region is delimited by the address of an identified device.

### CROSS REFERENCE TO RELATED APPLICATIONS

This application is based on and hereby claims priority to European Application No. EP 11190245 filed on Nov. 23, 2011, the contents of which are hereby incorporated by reference.

### BACKGROUND

Described below is a method for the identification, by a higher-level device, of devices combined in a communication network. Communication networks have different bandwidths in each case, and if a communication network includes other lower-order communication networks, so-called subnets, a separate bandwidth limitation may apply to each lower-order communication network.

Devices combined in a communication network, i.e. sensors and actuators for building automation, for example, can be addressed in groups or also in a cross-network manner so that they respond to an identification request with an identification code. In the case of the BACnet protocol widely used in building automation, for example, a telegram known as a “Who-Is” is provided as an identification request. Each device in the communication network responds to such a Who-Is identification request with an “I-Am” telegram, i.e. an identification code which includes at least the address of the respective device.

A “Who-Is” request is also suitable for broadcasting, thereby enabling a group of devices to be reached. However, in the case of an unknown or at least partially unknown communication network, and it is for such a communication network that the proposed method for identifying devices combined therein is intended to be used, it cannot be predicted how many devices can be reached using such a “Who-Is” request. A number of identification codes returned in response thereto may even fail to arrive because of the limited bandwidth of the communication networks. In the case of a communication network also including subnets, another difficulty is that routers or the like provided at network boundaries can also only forward a particular quantity of identification codes originating from the respective subnet and that packet losses and therefore losses in terms of the identification codes to be forwarded will inevitably result if a threshold value is exceeded in this respect.

Although a “Who-Is” or other identification request provides information about individual devices encompassed by the communication network, it does not necessarily provide information about all the devices encompassed thereby and, in identifying individual devices, there is no certainty as to whether other unidentified devices are encompassed by the communication network.

The communication network could in principle be scanned in sections by sending an identification request only for a particular region of the address space in each case, collecting the associated identification codes and then switching to the next address space. However, this is time consuming because, for example, regions of the address space containing no devices or only a small number of devices would then have be scanned with as much time and effort as regions having a large number of devices. For an iterative and static approach of this kind, the size of an address space region that can be scanned in an iteration step would necessarily be limited by the bandwidth and an assumption of the worst-case situation, namely that a device responds under each address encompassed by the address space region.

### SUMMARY

One aspect is a method for identifying devices combined in a communication network, which method identifies with sufficient certainty each device encompassed by the communication network and normally does so quicker than the above outlined scanning in consecutive regions of the address space.

In a method for the identification, by a higher-level device, of devices combined in a communication network wherein each device is assigned a unique address in a predefined address space, the following steps are provided for this purpose: the higher-level device subdivides the address space into request regions. The request region includes a variable, automatically determined number of addresses. The higher-level device sends an identification request to all the addresses in the request region. Devices which receive the identification request respond with an identification code containing at least the respective address thereof. The higher-level device collects the received identification codes and compares the number of received identification codes with a predefined threshold value. If the number of received identification codes is below the threshold value, the process is continued with a new request region bordering the request region. If the number of received identification codes is above the threshold value, the process is continued using a reduced request region which is a subset of the previous request region, the reduced request region being delimited by the address of an identified device.

An advantage of the method is that it monitors whether there is a sufficient probability or risk that, during a period of time, more identification codes were sent than could be reliably processed, and that addresses of identified devices are used for defining the limits of reduced request regions. The assessment as to whether more identification codes have been sent than can be reliably processed is carried out by comparing the number of actually received identification codes with a threshold value. As long as this threshold value is not exceeded, it can be assumed that all the identification codes sent have also actually been received. The threshold value is specified or specifiable for an algorithm used to implement the method, and is specifically dependent on the bandwidth of the communication network, the minimum bandwidth of any subnets, the speed with which routers or the like located at the net boundaries can forward data telegrams, etc. If the threshold value is exceeded, this merely indicates that a particularly large number of identification codes have been received, but not whether the number of identification codes received also corresponds to the number of identification codes actually sent. The request region is then reduced in order to reduce the number of incoming identification codes during a period of time. The sending out of the identification request and the collection of identification codes received is then repeated using the reduced request region. If the threshold value is then not exceeded, the request region is completely analyzed. If the threshold value is still exceeded, the request region is reduced still further. The notable feature here is that addresses of identified devices are used for defining the limits of reduced request regions. The size of the request region is therefore dynamic and does not involve tile-like, successive scanning of the address space of the communication network.

Back-references used in the dependent claims relate to further refinements of the subject matter of the main claim by virtue of the features of the particular dependent claim; they are not to be understood as a waiver of the right to independent, objective protection for the combination of features of the dependent claims to which they refer. In addition, having regard to an interpretation of the claims in the case of a more detailed concretization of a feature in a subordinate claim, it is to be assumed that such a restriction does not exist in the respective preceding claims.

A particularly easy way of implementing the method emerges if the address of an identified device defines an upper limit of the reduced request region. The lower limit of the previous request region can then continue to be used as the lower limit of the reduced request region. Even if the number of incoming identification codes remains below the threshold value for a request region and it is accordingly possible to switch to the next request region, the upper limit thereof is defined by the address of an identified device so as to produce dynamic request regions here also.

In an embodiment of the method it is provided that the starting point is a request region encompassing the entire address space. This ensures that even though, in the case of such an extensive request region, it is unlikely that the number of incoming identification codes will remain below the threshold value, a list of known devices and the addresses thereof will be filled in a uniformly distributed manner, for example, so that a uniformly distributed database can be drawn upon when using addresses of already identified devices.

In a particular embodiment, for automatically determining a variable request region it is provided that an address-ordered list of addresses of already identified devices is accessed using an access position referencing one element of the list in each case. The access position is incremented only if an identification code count remaining below the threshold value has been received in a request region and the latter is therefore completely analyzed, so that switching to the next request region can take place. One possibility for incrementing the access position is to increase the access position by precisely the number of identification codes received. If a request region could not be completely analyzed and must therefore be reduced, the access position remains unchanged, but even with an unchanged access position a lower upper limit value arises for the reduced request region because, in spite of the incomplete analysis of the request region, the list has received further list element(s) and thus, in the case of a list sorted by addresses, a lower address appears at the access position.

In another embodiment of the method it is provided that the starting point of the method is a number of already identified devices and, for subsequent runs of the method, a number of already identified devices in the respective request region, and that the number thereof is incorporated as a numerical value into an algorithm for implementing the method. A number of already identified devices has the advantage of a non-empty list of device addresses, so that such a list can be used from the outset. In addition, a number of already identified devices has the advantage that the addresses thereof are normally randomly distributed in the address space of the communication network so that a sufficient dynamic in respect of the automatic determination of the variable request regions is created.

The predefined threshold value can be calculated on the basis of the capacities of the network and any router capacities as well as other parameters. Tests have shown that the runtime of the method can normally be favorably influenced if a number of devices identified in the current request region is in the order of two-thirds of the threshold value.

The above may be achieved by a device for communicative connection to other devices in a communication network, which device acts at least sometimes as a higher-level device and operates in accordance with the method as described here and in the following. The method may be implemented in software and encompasses a computer program having computer-executable program code instructions and a storage medium containing such a computer program Also described below are an actuator, a sensor or a building automation control station in whose memory such a computer program is loaded or loadable for carrying out the method and the embodiments thereof.

### BRIEF DESCRIPTION OF THE DRAWINGS

An exemplary embodiment will now be explained in greater detail with reference to the accompanying drawings. Corresponding objects or elements are provided with the same reference characters in all the figures. The or each exemplary embodiment should not be interpreted as a limitation of the invention. On the contrary, within the scope of the present disclosure numerous changes and modifications are possible, in particular such modifications, elements and combinations that, for example, as a result of combinations or modifications of individual features or elements or method steps contained in the general or specific description and in the claims and/or in the drawings, can be comprehended by the average person skilled in the art as far as the achievement of the object is concerned and, as a result of combinable features, lead to a novel device or to novel method steps and/or sequences of method steps.

FIG. 1 is a block diagram of a number of devices combined in a network,

FIG. 2 is a graphical representation of an address space with request regions formed automatically therein,

FIG. 3 is a list of addresses at two points in time, in the left-hand area, a list of addresses of identified devices and, in the right-hand area, the list containing addresses newly added in the course of the method,

FIG. 4 is a schematically simplified flow chart of the method, and

FIG. 5 is a schematically simplified block diagram of a device operating as a higher-level device in the communication network.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

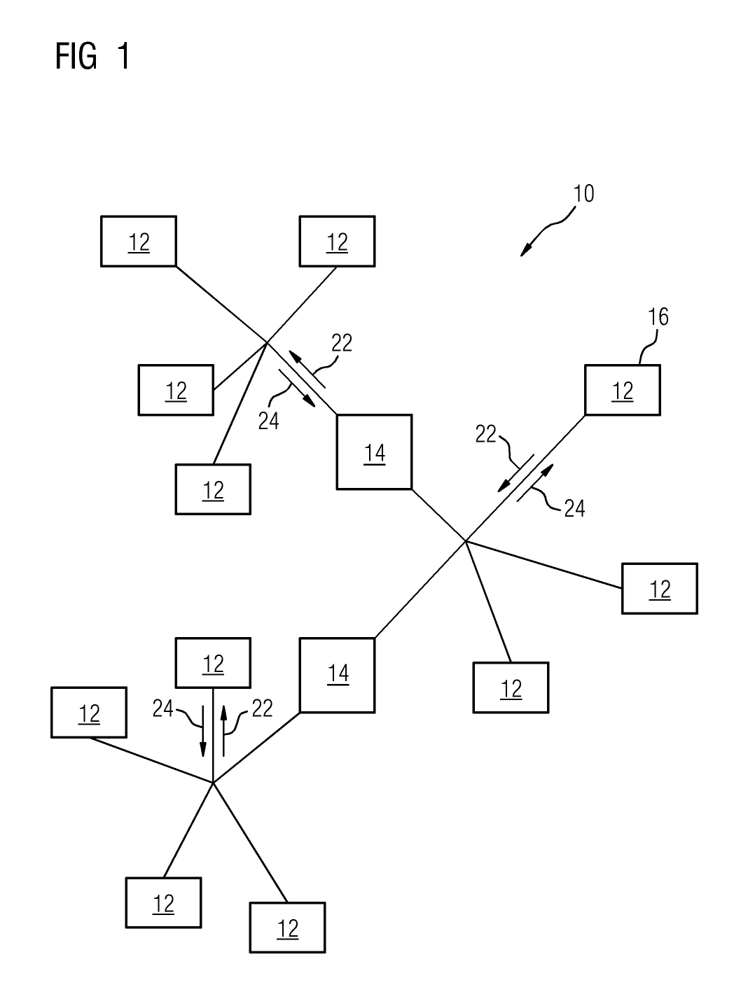

FIG. 1 shows in a schematically simplified manner a number of communicatively connected devices 10 combined in a communication network 10 hereinafter sometimes simply referred to a network for short, the devices 10 being, for example, actuators and/or sensors for building automation. The topology of the network 10 shown has been selected merely by way of example and is of no particular importance for the description which follows. It will merely be pointed out that the network 10 can include individual subnets and that a router 14 is provided at the transition to such a subnet.

For the method to be described, one of the devices 12 acts as a higher-level device 16. A higher-level device 16 can basically be any device 12, but specifically a device 12 that operates e.g. as a control station, i.e. a device 12 having sufficient memory and processing functionality for carrying out the method.

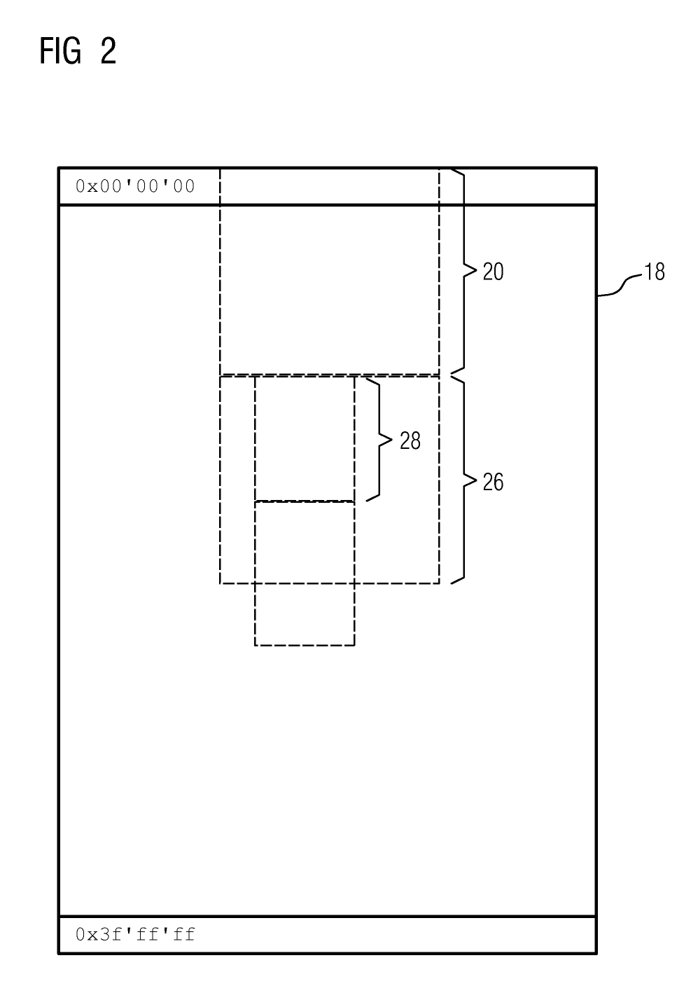

Each of the devices 12, 16 is reachable in the network 10 via an address exclusively allocated to the device, e.g. set or automatically assigned. For this purpose an address space 18 (FIG. 2) is specified and a valid address must belong to the address space. The address space is defined by a lower and an upper limit value and the smallest address that can be used in the network 10 corresponds to the lower limit value and the largest address that can be used in the network 10 corresponds to the upper limit value.

FIG. 2 shows a schematically simplified diagram of the address space 18. The smallest usable address and the largest usable address are specified by the hexadecimal value 0x00′00′00 (i.e. zero) and 0x3f′ff′ff respectively. These two addresses can—but need not—be used by a device 12 in the network 12 (FIG. 1). At any rate, each address of a device 12 included in the network 10 lies within the address space 18.

In the method it is provided that the higher-level device 16 subdivides the address space 18 into request regions 20. The method begins with a single request region 20 and, as it proceeds, new request regions 20 can arise which come to replace previous request regions 20. The request region 20 as a coherent part of the address space 18 is termed a request region 20 because, in order to identify devices 12 combined in the network 10, the higher-level device 16 either sends an identification request 22 to all the addresses in the request region 20 (FIG. 1) or sends such an identification request 22 to all the addresses in the address space 18 and only the devices 12 in the address space 18 respond thereto. To express this more simply, both scenarios, namely that a request is sent to all the addresses in the request region 20 or that a request is sent to all the addresses in the entire address space 18 and only the devices 12 in the request region 20 answer, are termed sending to all the addresses in the request region 20, because the desired result of the respective sending of the identification request 22—that devices 12 in the request region 20 respond with an identification code 24—is the same in both cases. In the case of an identification request broadcast to all the addresses in the entire address space 18, the underlying data telegram includes a specification of the respective request region 20, so that only the devices 12 belonging to the request region 20 respond to the broadcast.

The identification request 22 is indicated by an arrow in FIG. 1. This is actually a telegram transmitted in the network 10 in accordance with a protocol defined for the network 10 or subnets encompassed thereby, e.g. a so-called “Who-Is” telegram 22 when using the BACnet protocol (BACnet=Building Automation and Control Networks). In order not to unnecessarily complicate the diagram in FIG. 1, the transmission of the identification request 22 only to individual locations is shown. Devices 12 which receive the identification request 22 respond with an identification code 24 (FIG. 1) and such an identification code 24 is also only shown at individual locations. At all events, the identification codes 24 are collected and evaluated by the central device 16. Because the situation can arise that not all the identification codes 24 sent by the devices 12 contained in the network 10 reach the central device 16, the central device compares the number of received identification codes 24 with a predefined threshold value. The reasons why individual identification codes 24 do not reach the central device 16 can be, for example, that too many identification codes 24 must be forwarded via a router 14 and that, in the process, individual telegrams containing identification codes 24 are lost (packet loss). If the threshold value specified for the number of identification codes 24 is exceeded, although it is guaranteed that a larger number of identification codes 24 than the threshold value have been received, it is not clear whether yet more identification codes 24 were sent and in this case individual identification codes 24 have not reached the higher-level device 16.

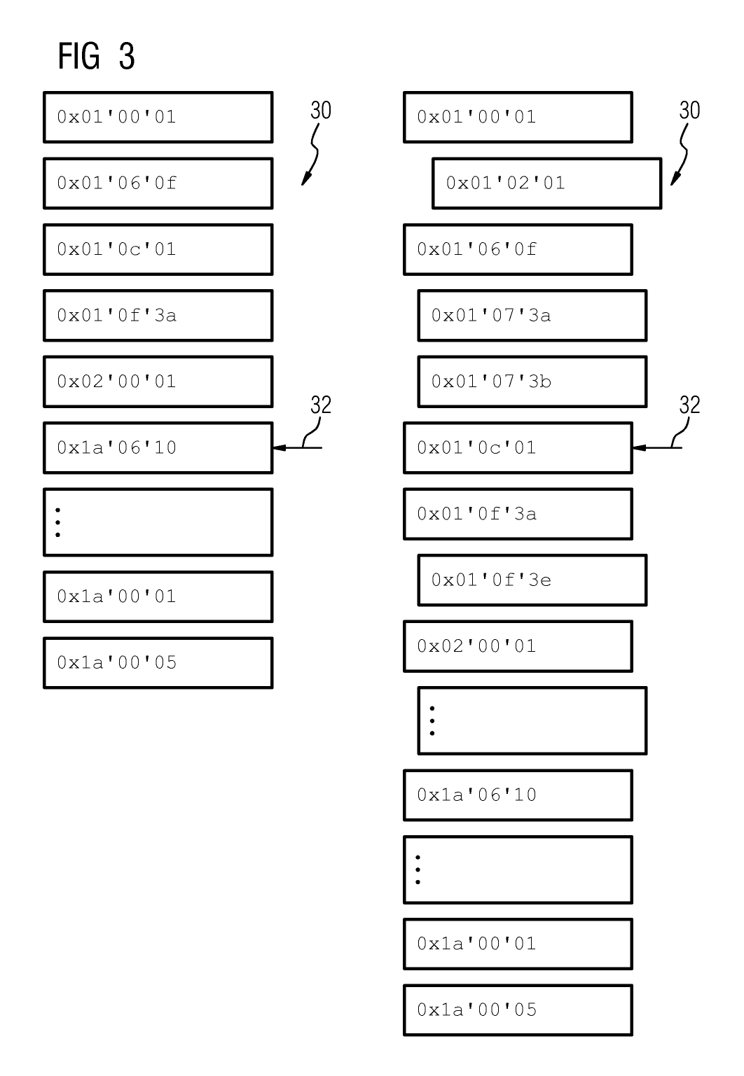

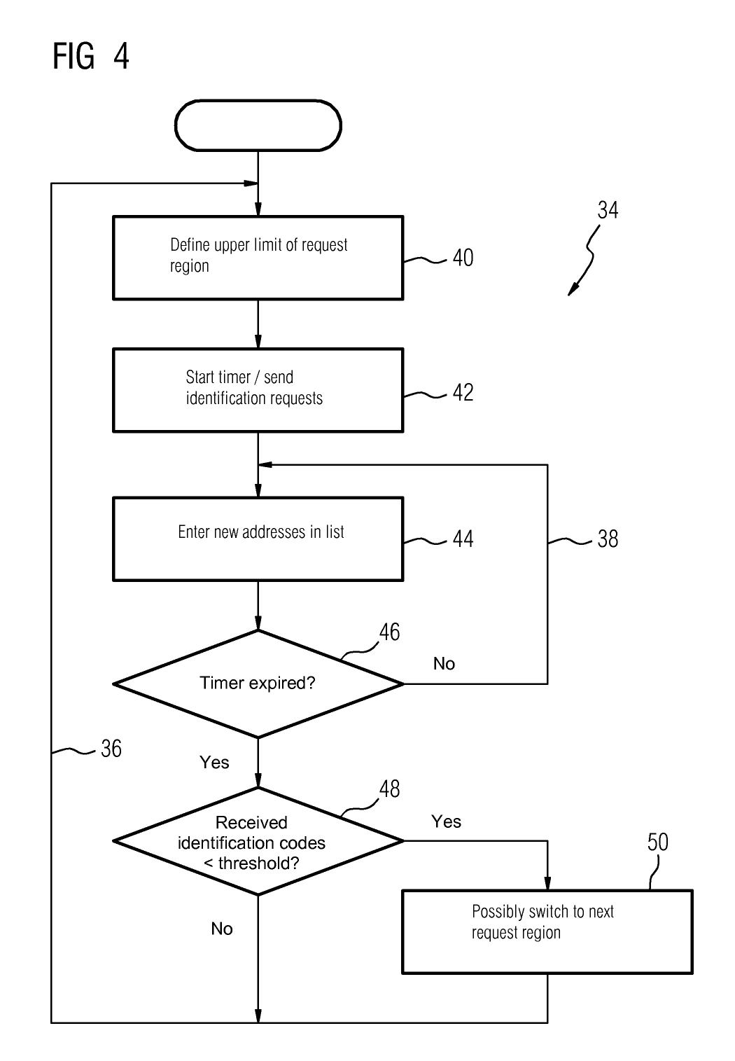

If the number of identification codes 24 received is below the threshold value, the method is continued with a new request region 26 (FIG. 2) bordering the request region 20 and identification requests 22 are transmitted again and resulting identification codes 24 collected. For the description which follows it will be assumed that the number of identification codes 24 received is above the threshold value. The method is then continues using a reduced request region 28 which is a subset of the previous request region 26. the reduced request region 26 is delimited by the address of an identified device 12. The identified device 12 can be a device 12 that has been determined in the course of the method wherein the number of incoming identification codes 24 has exceeded the threshold value or also a device 12 that has already been identified in advance. To explain this aspect, reference is made to the illustrations in FIG. 3 and FIG. 4.

FIG. 3 shows in schematically simplified form a data structure implemented as a field or as a list 30 in a computer program and in which at least the addresses of identified devices 12 are stored. The addresses shown are randomly selected and also not all the addresses are completely indicated symbolically. However, it can be seen that each identified address has a unique position in the list 30. The position of an address in the list 30 can change if lower addresses are entered in the list 30 when the list 30 is added to in connection with the identification of new devices 12.

The use of data from the list 30 takes place at an access position 32. The access position 32 is symbolically represented by an arrow in FIG. 3, because the access position 32 references a single element of the list 30, just as an arrow denotes such an element. When the method is implemented as a computer program, the access position is a numerical value or a so-called pointer.

The access position 32 is used to define the upper limit of a request region 20, 26, 28 by using the device address stored in the list element denoted by the access position 32. To explain this aspect, it is necessary to consider the diagrams in FIG. 3 and FIG. 4 in parallel.

FIG. 4 shows in schematically simplified form a flow chart 34 of an embodiment of the method described here. The flow chart 34 and correspondingly an implementation with computer program instructions includes an outer loop 36 and an inner loop 38. The outer loop 36 is executed until such time as the complete address space 18 has been processed. At the start of the outer loop 36, an upper limit of the respective request region 20, 26, 28 is defined (first block 40). The first time the outer loop 36 is executed, the lower limit value of the address space 18 is used as the lower limit of the request region 20. The resulting upper limit of the request region 20, 26, 28 is in each case the address of an already known device 12 and, to the end of the method, the upper limit value of the address space 18.

If the upper limit of the request region 20, 26, 28 emerges as the address of an already known device 12, the list 30 of already known devices 12 is accessed using the respective access position 32. The request region 20, 26, 28 therefore includes all the addresses between the lower and the upper limit thereof and therefore a variable, automatically determined number of addresses.

The first time the outer loop 36 is executed, the access position 32 and an index are set to zero and the list 30 of a number of already known devices 12 is accessed. A sum of the current status of the index and a constant, namely the number of already known devices 12, is actually always used as the access position 32. As a result of this summation, a single device number corresponding to the number of originally known devices 12 is normally present in each request region 20, 26, 28, namely even though when the method is executed repeatedly further devices 12 are identified and therefore the total number of identified devices 12 increases. The limiting of the request region also has the effect that the relation between the threshold value and a number of identified devices in the request region remains unchanged. An element from the list 30 is selected via the access position 32. The address stored there is used as the upper limit for the request region 20.

Then a timer is started, a variable for logging the incoming identification codes 24 is initialized, i.e. set to zero, and the identification requests 22 for the request region 20 are sent (second block 42). Timer expiry is monitored using the inner loop 38. The timer, i.e. a relevant software functionality, is initialized using a predefined or predefinable start value which encodes the period of time during which the inner loop 38 is executed. Within the inner loop 38, the incoming identification codes 24 are collected and the thereby encompassed addresses of the device 12 sending the respective identification code 24, if they are not contained in the list 30, are incorporated into the list 30 (third block 44). In addition, in the third block 44, with each identification code 24 received in the request region 20, a variable for the number of identification codes 24 received (“NumAnswers”) is incremented. As long as the timer has not expired, with the first inquiry 46 the flow chart branches back to the start of the inner loop 38.

After the end of the inner loop 38, i.e. again within the outer loop 36, it is checked whether the number of received identification codes 24, i.e. the value of the relevant variable (“NumAnswers”), is below the threshold value for a number of reliably processable identification codes 24. The threshold value is implemented in the method as a constant or as a variable and is initialized using a predefined or predefinable value dependent on a bandwidth of the network 10 and possibly encompassed subnets, the capacity of any routers 14, etc., as explained in the introduction. The checking for undershooting of the threshold value is implemented using a second inquiry 48. If the threshold value is undershot, the method is continued with a new request region 26 bordering the request region 20, i.e. switching to a next request region takes place (fourth block 50). For this purpose, the previous upper limit of the request region 20 can be used as the lower limit of the new request region; it will normally be provided that the address immediately following the previous upper limit forms the lower limit of the new request region. In order to define the upper limit of the new request region 26, in the fourth block 50 the index is also incremented by the number of received identification codes 24 (“NumAnswers”). The upper limit of the new request region 26 then emerges on re-execution of the outer loop 36 (first block 40) with accessing of the list 30 at the access position 32 defined by the sum of index and the number of originally known devices 12 or, if the list 30 contains insufficient elements for that purpose, using the upper limit of the address space 18.

If the second inquiry 48 has established that the number of received identification codes 24 attains or exceeds the threshold value, i.e. it cannot be safely assumed that all the identification codes 24 sent have also been received by the central device 16, the flow chart does not branch to the block 50, and the outer loop 36 is immediately repeated with a reduced request region 28. The lower limit of the request region from the previous execution of the outer loop 36 is used as the lower limit of the reduced request region 28. The upper limit of the reduced request region 28 emerges again with the accessing of the list 30 at the access position 32. The numerical value of the access position 32 has not changed if more identification codes 24 than can be reliably processed have been received. However, the contents of the list 30 have changed, so that the access position 32 possibly still denotes, for example, the two-hundredth element in the list 30, but the device address stored in the two-hundredth element in the list 30 is different from and in particular smaller than the upper limit of the preceding request region 26. FIG. 3 attempts to illustrate this graphically. Represented on the left-hand side of the diagram in FIG. 3 is a state of the list 30 after an execution of the outer loop 36 (FIG. 4). During the next execution the outer loop 36, further devices 12 are identified and accordingly new entries are added to the list 30 (indicated by the list elements disposed slightly offset on the right-hand side of the diagram). A list position 32 which has previously referenced, for example, a sixth element in the list 30, still references the sixth element thereof even after the list 30 has been added to. However, the address stored in the referenced element is now a different one—in the example “0x01′0c.01” instead the previous “0x1a′06′10”. In this way the size of the request region 26 is reduced. For the reduced request region 26 it is expected that the number of incoming identification codes 24 is at least smaller than for the previous execution of the outer loop 36. If the number of actually received identification codes 24 remains below the threshold value, a new request region can be selected at the end of the outer loop 36 (fourth block 50; FIG. 4). If the threshold value is still exceeded even for the reduced request region 26, no such switching to a new request region takes place and the outer loop 36 is re-run with the same access position 32 to the list 30. Because new list elements have again arisen during the previous execution of the outer loop 36, even with the access position 32 remaining unchanged a reduced upper limit for the request region is produced and the latter is therefore reduced again. The reduction of the request region therefore takes place until a number of identification codes 24 below the threshold value is received within the predefined timer period for the respective request region. This reduction of the request region means on the one hand that the request region includes a variable, but automatically determined number of addresses, because the upper limit of the request region is produced on the basis of the list 30 and the lower and upper limit of the request region therefore define a number of addresses encompassed by the request region which is therefore altogether automatically determined. On the other hand, however, the reduction of the request region means that the reduced request region is a subset of the previous request region, because it remains, for example, at a same lower limit.

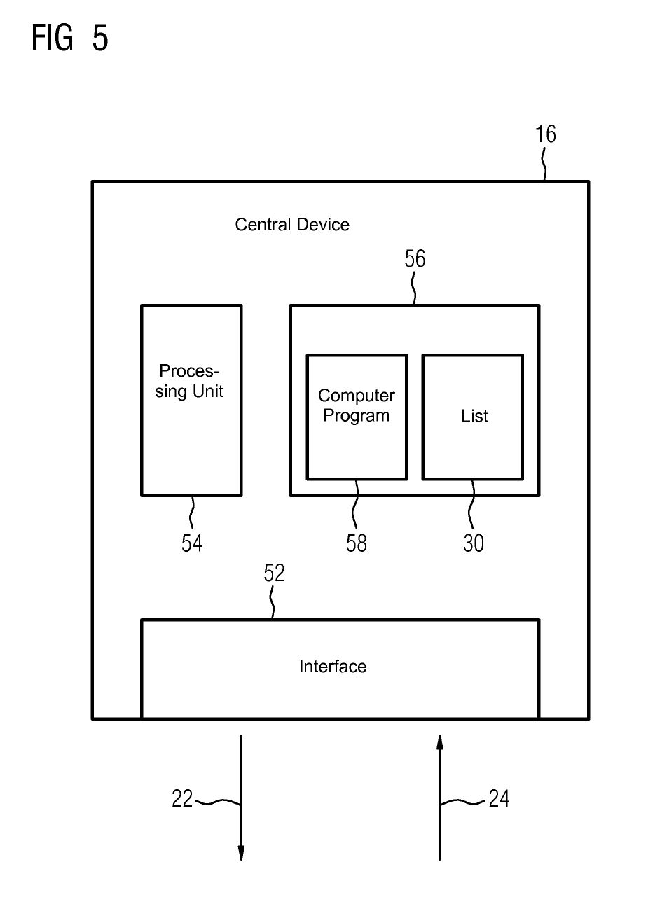

FIG. 5 finally shows a schematically simplified diagram of a higher-level device 16 designed to carry out the method described here. The higher-level device 16 includes—just like any other device 12 connected to the communication network 10—an interface 52. During operation of the higher-level device 16, in addition to other data telegrams, specifically identification requests 22 can be sent and identification codes 24 received via this interface 52. In addition, the higher-level device 16 has a processing unit 54 in the form or in the manner of a microprocessor and also a memory 56. Loaded into the memory 56 is a computer program 58 which represents the implementation of the method described here with any individual or a plurality of particular embodiments, in particular an implementation of the flow chart 34 from FIG. 4. Also stored in the memory 56 is the list 30 of identified devices 12. During operation of the higher-level device 16, the processing unit 54 thereof executes the computer program 58, thus causing the method described here to be carried out. The processing unit 54, the memory 56 and the computer program 58 are consequently means for carrying out the method.

Individual primary aspects of the description submitted here may therefore be briefly summarized as follows: specified is a method for identifying devices 12 combined in a communication network 10 by a device 12 acting as a higher-level device 16 in the communication network 10, wherein each device is assigned a unique address 12 in a predefined address space 18, including the following: the higher-level device 16 automatically subdivides the address space 18 into request regions 20. The request region 20 includes a variable, automatically determined number of addresses. According to the above definition, the higher-level device 16 sends an identification request 22 to all the addresses in the request region 20. Devices 12 which belong to the request region 20 and receive the identification request 22 answer with an identification code 24. The higher-level device 16 collects the identification codes 24 received and compares a number of identification codes 24 received with a predefined threshold value. If the number of received identification codes 24 is below the threshold value, the method is continued with a new request region 20 bordering the request region 20. If the number of received identification codes 24 is above the threshold value, the method is continued using a reduced request region 20 which is a subset of the request region 20, the reduced request region 20 being delimited by the address of an identified device 12.

The higher-level device 16 may include permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for identification, by a higher-level device, of devices combined in a communication network, each device being assigned a unique address in a predefined address space, comprising:
subdividing an address space into request regions by the higher-level device, each request region having a variable, automatically determined number of addresses;
sending an identification request from the higher-level device to all the addresses in the request region;
answering, by the devices which receive the identification request, with an identification code;
collecting, by the higher-level device, the identification codes received from the devices;
comparing the number of identification codes received with a predefined threshold value;
obtaining, if a number of identification codes received is below the threshold value, a new request region bordering the request region;
obtaining, if the number of the identification codes received is above the threshold value, a reduced request region which is a subset of the request region, the reduced request region delimited by an address of an identified device; and
repeating said sending, answering, collecting and comparing using whichever of the new request region and the reduced request region was obtained.

2. The method as claimed in claim 1, wherein an upper limit of the reduced request region is defined by the address of the identified device.

3. The method as claimed in claim 2, wherein the request region initially encompasses all of the address space.

4. The method as claimed in claim 1, wherein, when the new request region borders the request region, an upper limit of the new request region is defined by the address of the identified device.

5. The method as claimed in claim 4,
further comprising generating a list of identified devices sorted by the addresses of the devices, and
wherein the address of the identified device defining the upper limit of the new request region is stored in the list at an access position.

6. The method as claimed in claim 5,
wherein said obtaining of the new request region, when the number of the identification codes received is below the threshold value, is accomplished by increasing the access position by the number of identification codes received, and
wherein said obtaining of the reduced request region is accomplished by the access position remaining unchanged when the number of identification codes received is above the threshold value.

7. The method as claimed in claim 1, further comprising:
determining, prior to said subdividing, an initial number of previously identified devices; and
incorporating the initial number as a numerical value in an algorithm for implementing the method.

8. A non-transitory computer readable medium embodying program code that when executed on a device acting as a higher-level device in a communication network performs a method for identification of devices combined in a communication network, each device being assigned a unique address in a predefined address space, comprising:
subdividing an address space into request regions by the higher-level device, each request region having a variable, automatically determined number of addresses;
sending an identification request from the higher-level device to all the addresses in the request region;
answering, by the devices which receive the identification request, with an identification code;
collecting, by the higher-level device, the identification codes received from the devices;
comparing the number of identification codes received with a predefined threshold value;
obtaining, if a number of identification codes received is below the threshold value, a new request region bordering the request region;
obtaining, if the number of the identification codes received is above the threshold value, a reduced request region which is a subset of the request region, the reduced request region delimited by an address of an identified device; and
repeating said sending, answering, collecting and comparing using whichever of the new request region and the reduced request region was obtained.

9. The non-transitory computer program readable medium as claimed in claim 8, wherein an upper limit of the reduced request region is defined by the address of the identified device.

10. The non-transitory computer program readable medium as claimed in claim 9, wherein the request region initially encompasses all of the address space.

11. The non-transitory computer program readable medium as claimed in claim 8, wherein, when the new request region borders the request region, an upper limit of the new request region is defined by the address of the identified device.

12. The non-transitory computer program readable medium as claimed in claim 11,
said method further comprising generating a list of identified devices sorted by the addresses of the devices, and
wherein the address of the identified device defining the upper limit of the new request region is stored in the list at an access position.

13. The method as claimed in claim 12,
wherein said obtaining of the new request region, when the number of the identification codes received is below the threshold value, is accomplished by increasing the access position by the number of identification codes received, and
wherein said obtaining of the reduced request region is accomplished by the access position remaining unchanged when the number of identification codes received is above the threshold value.

14. The non-transitory computer program readable medium as claimed in claim 8, further comprising:
determining, prior to said subdividing, an initial number of previously identified devices; and
incorporating the initial number as a numerical value in an algorithm for implementing the method.

15. An electrical device which acts at least sometimes as a higher-level device in a communication network communicating with further devices, comprising:
a memory storing a computer program; and
a processing unit executing the computer program during operation of the electrical device to perform operations including
subdividing an address space into request regions by the higher-level device, each request region having a variable, automatically determined number of addresses;
sending an identification request from the higher-level device to all the addresses in the request region;
answering, by the devices which receive the identification request, with an identification code;
collecting, by the higher-level device, the identification codes received from the devices;
comparing the number of identification codes received with a predefined threshold value
obtaining, if a number of identification codes received is below the threshold value, a new request region bordering the request region;
obtaining, if the number of the identification codes received is above the threshold value, a reduced request region which is a subset of the request region, the reduced request region delimited by an address of an identified device; and
repeating the sending, answering, collecting and comparing using whichever of the new request region and the reduced request region was obtained.

16. The electrical device as claimed in claim 15, wherein an upper limit of the reduced request region is defined by the address of the identified device.

17. The electrical device as claimed in claim 16, wherein the request region initially encompasses all of the address space.

18. The electrical device as claimed in claim 15, wherein, when the new request region borders the request region, an upper limit of the new request region is defined by the address of the identified device.

19. The electrical device as claimed in claim 18,
wherein the operations performed by said processing unit further include generating a list of identified devices sorted by the addresses of the devices, and
wherein the address of the identified device defining the upper limit of the new request region is stored in the list at an access position.

20. The electrical device as claimed in claim 19,
wherein the obtaining of the new request region, when the number of the identification codes received is below the threshold value, is accomplished by increasing the access position by the number of identification codes received, and
wherein the obtaining of the reduced request region is accomplished by the access position remaining unchanged when the number of identification codes received is above the threshold value.

21. The electrical device as claimed in claim 15, further comprising:
determining, prior to the subdividing, an initial number of previously identified devices; and
incorporating the initial number as a numerical value in an algorithm for implementing the method.
